(19) United States
(12) Patent Application Publication
(10) Pub. No.: US 2023/0368314 A1
(43) Pub. Date: Nov. 16, 2023

(54) VIRTUAL DINING SYSTEM AND APPARATUS FOR RESTAURANTS AND FOR OTHER DINING VENUES

(71) Applicant: Peter Pastor, Scottsdale, AZ (US)

(72) Inventor: Peter Pastor, Scottsdale, AZ (US)

(21) Appl. No.: 18/139,633

(22) Filed: Apr. 26, 2023

Related U.S. Application Data
(60) Provisional application No. 63/341,747, filed on May 13, 2022.

(51) Int. Cl. G06Q 50/12; H04N 23/60; H04R 1/02; A47C 7/72

(52) U.S. Cl. CPC G06Q 50/12; A47C 7/723; A47C 7/727; H04N 23/60; H04R 1/028; H04R 2499/15

(57) ABSTRACT

A virtual dining system where at least two diners may eat and communicate with each other in at least two remote locations. The system includes stations which permit a diner to be viewed and spoken to through audio and video connections which simulate another diner’s presence.

### CROSS-REFERENCE

This application claims the benefit of U.S. Application Serial No. 63/341,747, filed May 13, 2022, which is incorporated by reference herein.

### SUMMARY OF THE INVENTION

This invention relates to a virtual dining system wherein at least two diners may eat and communicate with each other in at least two remote locations. The system includes stations which permit a diner to be viewed and spoken to through audio and video connections which simulate another diner’s presence.

A particular feature of the system is a virtual presence chair (“VP Chair”). The VP Chair is a station that has the appearance of a chair including a frame and can be brought to a table to support the virtual dining system.

### BRIEF DESCRIPTION OF THE DRAWINGS

FIG. 1 is a front elevational view of a station used in the system of the invention;

FIG. 2 is a right-side front perspective view of the station shown in FIG. 1;

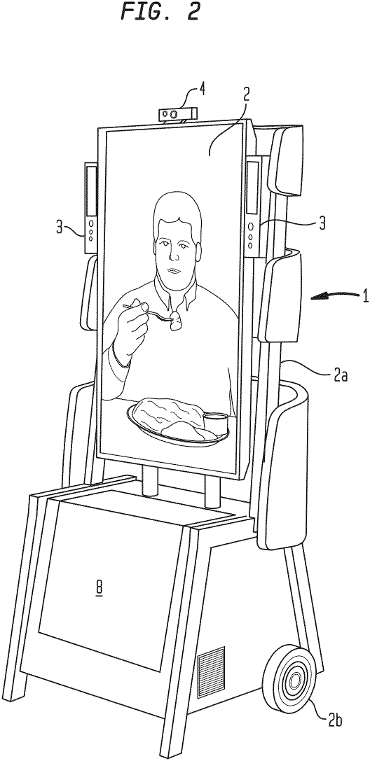

FIG. 3 is a right-side rear perspective of the station shown in FIG. 1;

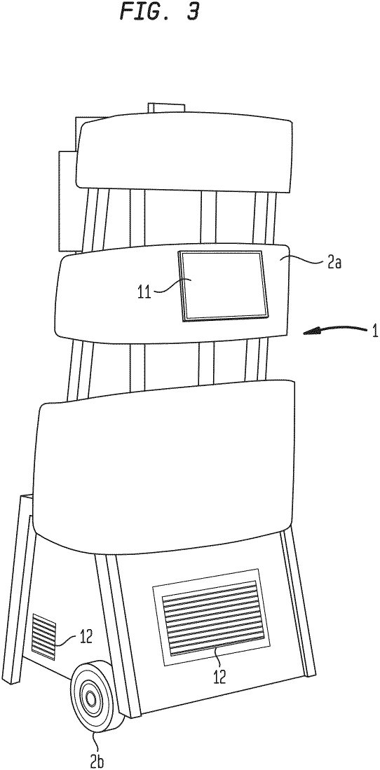

FIG. 4 is a partial front view of the station shown in FIG. 1, with the cabinet opened;

FIG. 5 is a partial front view of the station shown in FIG. 1, with the cabinet closed;

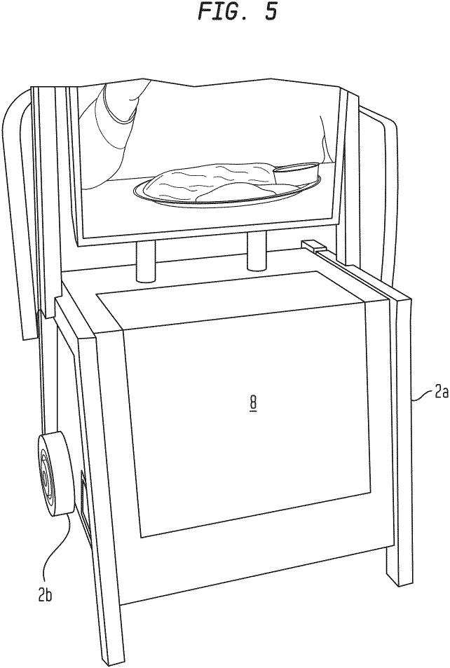

FIG. 6 is a view of the system in operational mode;

FIG. 7 is a right-side rear perspective view of the station shown in FIG. 3;

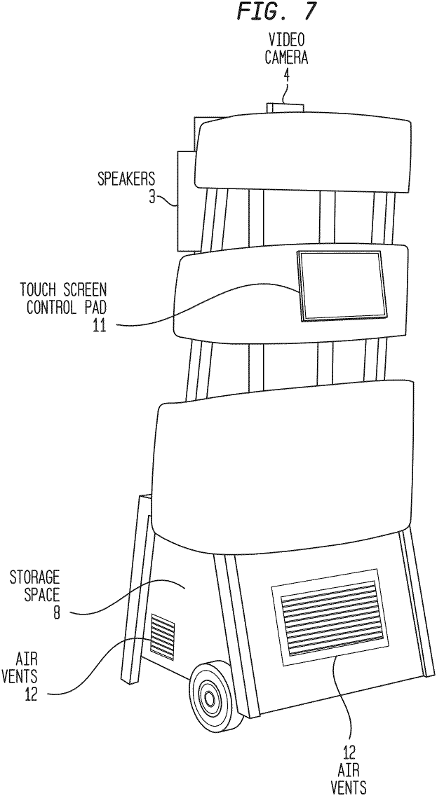

FIG. 8 is a right-side rear front perspective view of the station shown in FIG. 2;

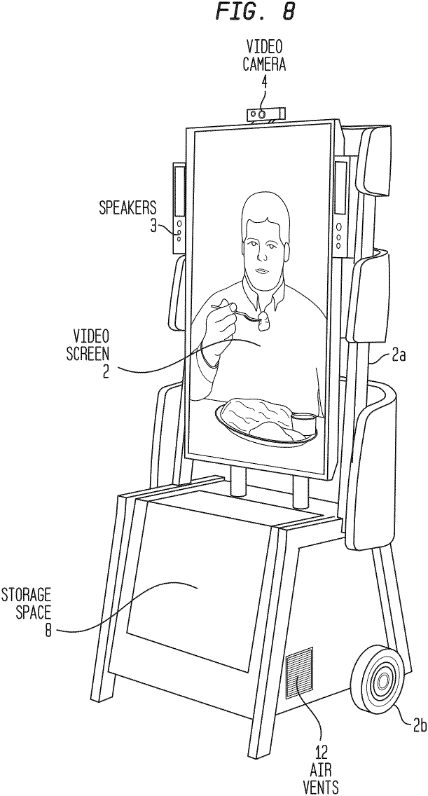

FIG. 9 is a front elevational view of the station shown in FIG. 1; and

FIG. 10 is a partial front view of the station shown in FIG. 4;

### DETAILED DESCRIPTION

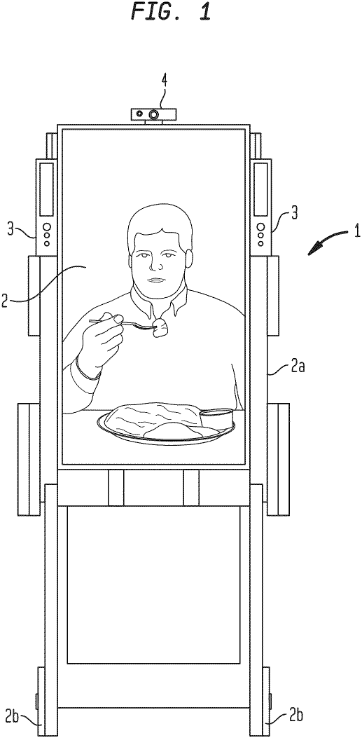

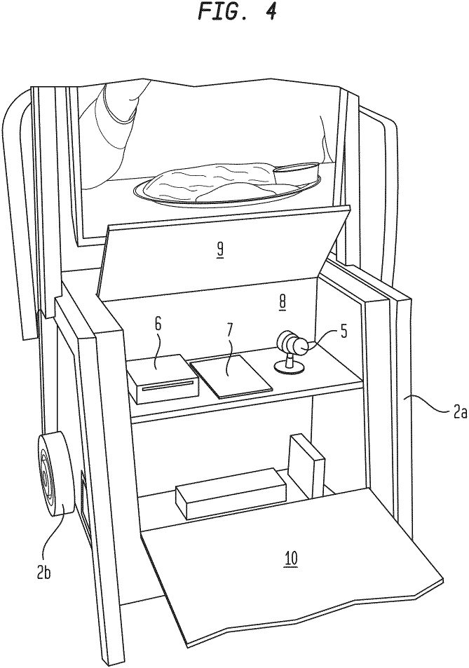

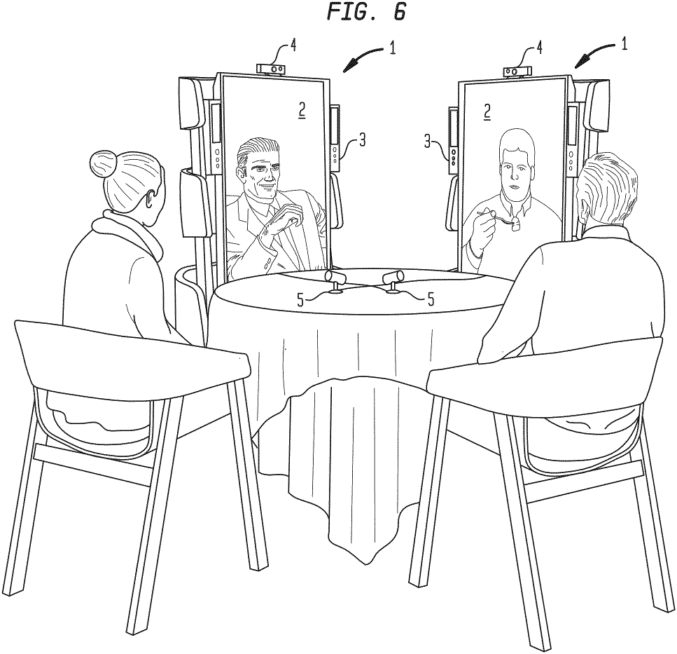

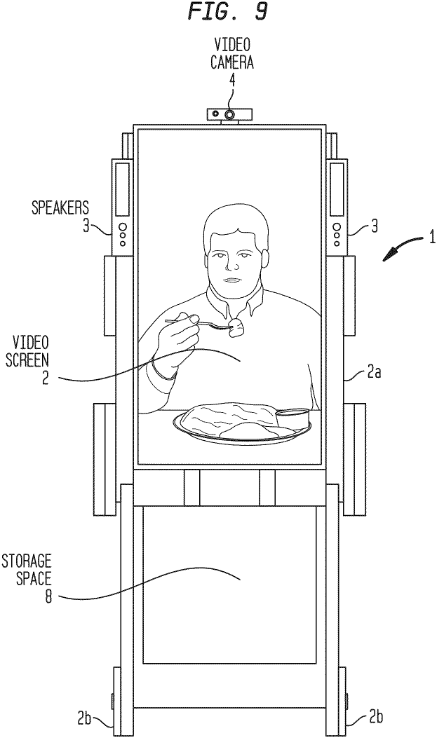

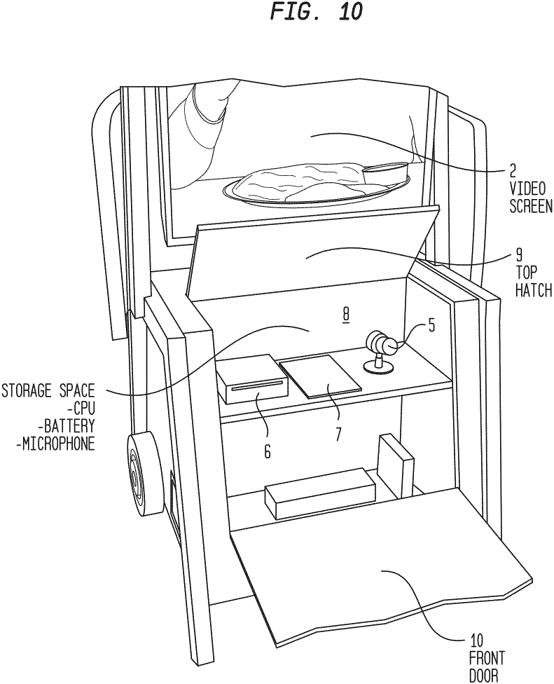

The VP Chair 1 has two purposes. First, it is positioned at a table to virtually represent a person joining the meal occasion from a remote location. Second, it is there to capture the video and voice of a live person at the table (sitting opposite the chair) for broadcast to the remote dining location. VP Chairs, as shown in FIGS. 1 and 9, are intended to be deployed in pairs, one at each restaurant location. Components of the VP Chair are as follows:
a. A video screen or monitor 2 (approximately 40″ diagonal, 35″ height by 20″ wide) to represent a person in their actual proportions at the appropriate height above the tabletop facing towards the table. The VP Chair frame 2a holds the screen and has a high back to hide the video screen from viewing from behind. The VP chair also has wheels 2b so that it can be readily positioned for use.
b. A speaker system 3 to carry the voice of the virtual attendee to those at the physical location. The system is comprised of two speakers on the sides of the video screen facing the table at approximately face height.
c. A video camera 4 atop the video screen to capture the person at the physical location directly across the table from the virtual attendee.
   i. The video camera and software recognize a person across from it, gauges distance, and frames the person for projection to the remote location so that the remote picture represents the person clearly and true to size.
   ii. The video camera picture adapts automatically to different light conditions and the background behind the person being viewed.
d. Two sets of microphones 5, as shown in FIGS. 4, 6 and 10. A wired (or wireless) directional microphone is used to capture the voice of the person across the table from the virtual attendee. Additionally, there are microphone(s) attached to the back of the VP Chair to pick up background noise.
   i. Noise cancellation software works to screen out irrelevant background sounds so that a clear voice can be projected to the remote location.
e. Data processing system 6, as shown in FIGS. 4 and 10. This system captures, processes and broadcasts video and voice signals from the current location to the remote location and receives video and voice signals from the remote location to be represented on the VP Chair display and speakers.
   i. Data processing system is high speed Wi-Fi/Bluetooth enabled.
   ii. On the back panel of the VP Chair is an on/off button and small touch screen to activate the VP Chair and input information regarding the dining session.
f. A battery 7, as shown in FIGS. 4 and 10. The battery powers all electronics associated with the VP Chair.
The data processing system 6, battery 7 and a microphone 5 may be positioned within a storage compartment 8. The compartment may have a top 9 and front door 10. Air vents 12 may be used to cool the electronics.

To use the virtual dining system, there should be a food and beverage table delivery coordination system. That system coordinates food preparation and table service between two locations participating in a virtual dining experience and comprises a processing system which coordinates the virtual dining system.

The coordination system consists of two 2-way communications devices that are used one at each remote dining location per dining experience. A reservation number is input to devices to activate them for an event. The first screen that appears has a box to check once all the local guests have arrived. As guests arrive, drink orders can be taken at the remote locations independently. Once both locations have reported that guests are in attendance, a new screen pops up which shows the correct local time and a suggested “take order” time. Each location can either accept the suggested take order time or add minutes to the suggested time. Once both locations have either accepted the suggested time, or if added time has been requested, a count-down clock appears, counting down to the “later” time requested. Therefore, if one locale accepted the suggested time, but the other location requested 5 minutes later, the 5 minutes later time is the time used. At the end of the count down a “Ready” button appears. Once both locations have clicked the “Ready” button, a Message “Go take Orders” appears on the screen. Next each device asks, “Is there an Appetizer/Salads course,” with a Yes/No response. If both locations respond Yes, a process starts, similar to the process for taking orders, first proposing a suggested “serve Appetizer/Salads” time. If one location has an Appetizers/Salads course and the other doesn’t, the location with Appetizers/Salads will show a message, “Serve Appetizers/Salads at will - check box below when served”, while that other location will show a message stating, “Other location is serving Appetizers/Salads - Hold for main meal order”. Once the location serving Appetizers/Salads has designated they have been served, or if neither location is having Appetizers/Salads, then the next screen appears.

The main meal service portion of the experience starts with a similar process suggesting a “Serve Main Meal” time and continues as previously described.

After the main meal has been served, a screen pops up with a “Main Meal Plates have been cleared from Table” check box. Once both locations have checked that box, an “Ask about desserts/coffee” suggested time box appears, and the process continues. Depending on the response there can be a count-down to dessert/coffee service and finally there is a countdown for “presentation of Check” After checks have been presented the 2-way communications devices default back to an “Enter reservation screen” for their next use.

Virtual dining experiences should be booked in advance through an on-line reservation system. This may be through an existing reservation system that decides to accommodate virtual dining, or a stand-alone system. In either case the system will operate similar to existing reservation systems. When entering the reservation systems (if not a dedicated system), a user selects that he/she/they is making a “Virtual Dining” reservation. They next indicate key information about the reservation they are seeking to book, eg, What are the two locations where attendees are dining (city/state); How many total attendees (for example if four persons at each location, the total would be 8); For what date and time (one must specify the time zone). Once one has entered the key reservation information, a list of restaurants participating in the program who have available capacity for virtual dining on the day/time of the request will be listed for the first city. The user then makes a first selection. Then a list of restaurants will appear for the second city. The user then makes a second selection. Finally, a summary of the reservation will be shown for approval and a reservation number will be assigned. This information is then communicated to the participating restaurants.

A backend cloud-based system of the type known in the art is used to handle operational elements of the virtual dining system. This includes: Receiving and transmitting video and audio signals between VP Chairs during a dining session; Management of 2-way table delivery coordination system; and Integration with the restaurant reservation system.

In order to activate the system for a dining session, prior to the reservation time, the VP Chairs are set at the table. The VP Chairs 1 must all be adjacent to each other. Once the local attendees have been seated, the VP Chairs are activated. The power is turned on. Once the unit has powered up it will prompt for the reservation number and then it will prompt for the position number. A touch screen control panel 11 or on-off button may be on the rear of the frame 2a. The positions are designated 1, 2, 3 and so on, if at the center of the table looking at the chairs, starting to the left and going clockwise. Seat position numbers are necessary so that the appropriate units at the two locations are paired together. If the unit has not paired with its remote unit, it means the other attendees have not yet arrived and the screen will remain blank. Once both sides are in attendance, the units will pair and the VP Chairs will represent their appropriate meal attendees.

Other uses of the invention may become apparent upon review of the drawings without departig from the spirit or scope of the invention.

What is claimed is:

1. A station for use in a virtual dining environment comprising at least two diners eating and communicating with each other in at least two remote locations, the station comprising:
a. a chair frame;
b. a video monitor positioned on the chair frame;
c. a video camera and associated video connection positioned on the monitor and/or on the chair frame; and
d. a microphone, a speaker and associated audio connection positioned on the monitor and/or on the chair frame, where one diner may substantially simultaneously communicate with another diner through the audio connection and be observed by another diner through the video connection at a remote location, such that the diners simulate eating a meal together while they are physically present in different locations.

2. A station as defined in claim 1, further comprising a processing unit for the audio and video connections positioned on the chair frame.

3. A station as defined in claim 1, wherein the monitor is sized so that it displays an image representing a diner of actual physical proportions.

4. A station as defined in claim 1, communicating audibly and visually with another station.

5. A system for a virtual dining environment wherein at least two diners eat and communicate with each other in at least two remote locations, each diner being represented in their actual physical proportions, the system comprising:
a. a first chair, comprising
(i) a first frame,
(ii) a first video monitor positioned on the first frame,
(iii) a first video camera and associated first video connection positioned on the first monitor and/or on the first frame, and
(iv) a first microphone, first speaker and associated first audio connection positioned on the first monitor and/or the first frame, and
b. a second chair, at a remote location from the first chair, comprising
(i) a second frame,
(ii) a second video monitor positioned on the second frame,
(iii) a second video camera and associated second video connection positioned on the second monitor and/or on the second frame, the second video connection communicating with the first video connection, and
(iv) a second microphone, second speaker and second associated audio connection, the second audio connection communicating with the first audio connection, and positioned on the second monitor and/or the second frame, and
c. a processing unit for connecting the audio and video connections of the first and second chairs, wherein the diners virtually simulate eating a meal together while they are physically in different locations.

6. A system as defined in claim 5, wherein the processing unit allows two-way communication and observation of the two diners.

7. A system as defined in claim 5, wherein the first and second chairs are coordinated such that they may be substantially simultaneously activated for a dining event.

8. A system as defined in claim 5, wherein the first and second chairs are coordinated such that they may be substantially simultaneously activated for ordering and serving meals.

9. A system as defined in claim 5, wherein there are an equal number of in person and virtual diners at each remote station.

10. A system as defined in claim 5, wherein there are more than two in person and remote diners at each location.
